(19) United States
(12) Patent Application Publication
(10) Pub. No.: US 2014/0115525 A1
(43) Pub. Date: Apr. 24, 2014

(54) SYSTEMS AND METHODS FOR INTEGRATED QUERY AND NAVIGATION OF AN INFORMATION RESOURCE

(71) Applicant: LEAP2, LLC, Kansas City, KS (US)

(72) Inventor: Michael William Farmer, Kansas City, KS (US)

(73) Assignee: LEAP2, LLC, Kansas City, KS (US)

(21) Appl. No.: 13/824,729

(22) PCT Filed: Sep. 19, 2012
(86) PCT No.: PCT/US12/56085

§ 371 Date: Mar. 18, 2013

Related U.S. Application Data
(60) Provisional application No. 61/533,337, filed on Sep. 12, 2011.

(51) Int. Cl. G06F 3/0484

(52) U.S. Cl. CPC G06F 3/0484
USPC 715/780

(57) ABSTRACT

Systems and methods are provided to enable an integrated query and navigation system. A graphical user interface is provided that simultaneously displays a query entry frame and a resource display frame. The query navigator includes a query input mechanism that receives input and displays suggested query terms and representative images for articles for matching content. The resource display frame enables a user to view query information and content information in the same interface as to be informed and make decisions on that information.

### FEDERALLY SPONSORED RESEARCH OR DEVELOPMENT

Not Applicable.

### COMPACT DISK APPENDIX

Not Applicable.

### BACKGROUND

Conventional information retrieval systems have primarily been designed for the desktop computer to assist users in finding information stored on a computer system, either networked or locally. Information retrieval systems, also known as search engines, usually present search results in a list format to allow users to view the search results and determine which web page or other web service they want to read or access. Over the last decade, most information retrieval activity has been conducted on desktop computers that are equipped or connected to monitors that typically have approximately 100 square inches of screen real estate.

Desktop computers are also typically equipped or connected to a qwerty-type keyboard to allow users to enter query or search terms, and a mouse controller to allow the user to navigate lists and pages of search results. This hardware configuration has enable user to quickly review many search results and to select a result that the user believes contains the information they were seeking. If a webpage did not include the desired information, the user could either select a different result or enter a new query into a search tool, such as a search engine box.

Improvements in computer technology have led to the proliferation of a new generation of computer-devices and/or platforms, primarily of the mobile-type. Mobile-type devices generally have significantly less screen real estate (e.g., on average six square inches) and are equipped with software-based controllers such as soft-keyboards, touch sensitive screens, or voice recognition system to allow the user to input a query and navigate to an answer. Because mobile-type devices are often used while the user is in motion (i.e., mobile), the user profile of such device is often significantly different than the user profile of the desktop computer.

In general, mobile users usually have a need to follow-up their information retrieval activity with some form of action. For example, after retrieving information about a particular restaurant, the user may want to initiate a call to that particular restaurant. Other forms of actions taken on the information retrieved may include, for example, sending an email or message, bookmarking a page, commenting on a site via facebook, or tweeting about the information. Unfortunately, search systems built on the legacy of providing information retrieval for the desktop computer were not designed and optimized for the unique needs of mobile users. Furthermore, many web resources that search engine access were not developed with a mobile user in mind.

### SUMMARY

According to one aspect, a system is provided for retrieving and displaying an information resource. The system includes a computing device comprising at least one processor and at least one data source. The data source includes a plurality of first objects and a plurality of second objects. Each of the plurality of first objects includes first object data that defines at least one suggested term for a corresponding character entry and identifies location data for an information resource that corresponds to each suggested term. Each of the plurality of second objects includes second object data that defines at least one symbol for the corresponding character entry and identifies other location data for another information resource that corresponds to each symbol.

The system also includes an application that is executable by the at least one processor to generate a graphical user interface at a display connected to the computing device. The graphical user interface includes an information resource frame and a query frame. The query frame includes an input field, a first display window, and a second display window. The executed application also retrieves at least one suggested term from the data source that corresponds to a particular character entry input at the input field. The executed application also retrieves at least one symbol from the data source that corresponds to the particular character entry input at the input field. The executed application also displays the at least one suggested term in the first display window and displays the at least one symbol in the second display window. The executed application also displays a particular information resource in the information resource frame in response to a selection of a particular corresponding symbol displayed in the second display window.

According to another aspect, a computing device encoded with an integrated query and navigation application comprising modules executable by a processor is provided to retrieve and display an information resource. The integrated query and navigation application includes a GUI module to generate a graphical user interface at a display of the processing device. The graphical user interface includes an information resource frame and a query frame. The query frame includes an input field, a first display window, and a second display window. The integrated query and navigation application also includes a first retrieval module to retrieve a plurality of first objects from a data source that corresponds to a particular character entry input at the input field. Each of the plurality of first objects includes first object data that defines at least one suggested term for a corresponding character entry and that identifies location data for an information resource that corresponds to each suggested term. The integrated query and navigation application also includes a second retrieval module to retrieve a plurality of second objects from a data source that corresponds to a particular character entry input at the input field. Each of the plurality of second objects includes second object data that defines at least one symbol for the corresponding character entry and that identifies other location data for another information resource that corresponds to each symbol. The integrated query and navigation application further includes a display module to display the at least one suggested term in the first display window, display the at least one symbol in the second display window, and display a particular information resource in the information resource frame in response to a selection of a particular corresponding symbol displayed in the second display window.

According to another aspect, a method is provided for retrieving and displaying an information resource. The method includes generating a graphical user interface at a display of a processing device. The graphical user interface includes an information resource frame and a query frame that includes an input field, a first display window, and a second display window. The method also includes retrieving a plurality of first objects from a data source that correspond to a particular character entry input at the input field. Each of the plurality of first objects includes first object data defining at least one suggested term for a corresponding character entry and identifying location data for an information resource that corresponds to each suggested term. The method also includes retrieving a plurality of second objects from a data source that corresponds to a particular character entry input at the input field. Each of the plurality of second objects includes second object data defining at least one symbol for the corresponding character entry and identifying other location data for another information resource that corresponds to each symbol. The method also includes displaying the at least one suggested term in the first display window, displaying the at least one symbol in the second display window, and displaying a particular information resource in the information resource frame in response to a selection of a particular corresponding symbol displayed in the second display window.

### BRIEF DESCRIPTION OF THE DRAWINGS

FIGS. 1A-1B are block diagrams of computing environments for retrieving and displaying information resources according to aspects of an integrated query and navigation system.

FIG. 2 is a block diagram of an integrated query and navigation application according to one aspect of the integrated query and navigation system.

FIG. 3A is an exemplary integrated query and navigation system form according to one aspect of the integrated query and navigation system.

FIGS. 3B-3O are screen shots of data entry forms according to one aspect of the integrated query and navigation system.

FIG. 4 is a flow chart depicting a method for retrieving and displaying information resources according to aspects of an integrated query and navigation system.

### DETAILED DESCRIPTION

Aspects of an integrated query and navigation system (IQNS) described herein enable a user to view an information resource and generate a query via a single interactive graphical user interface. The user interface includes a query section that displays selectable objects in the form of suggested search terms and/or images representative of information resources in response to a user entering one or more characters of a search string (e.g., word, term.) Thereafter, the user can interact with the user interface to highlight or select a particular suggested term and/or a particular image to view a corresponding information resource in a resource display section of the user interface.

According to other aspects, the IQNS uses one or more rules to identify suggested search terms and/or images to display via the graphical user interface in response to user input. The IQNS also enables users to generate a query by highlighting or selecting text within an information resource being displayed in the navigation section of the user interface.

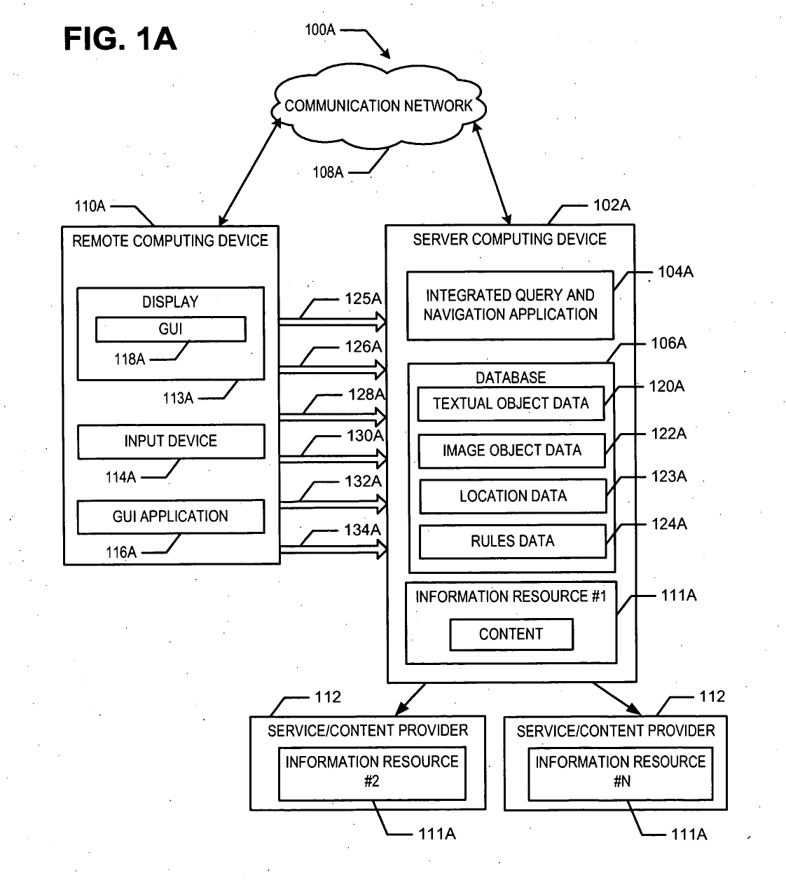

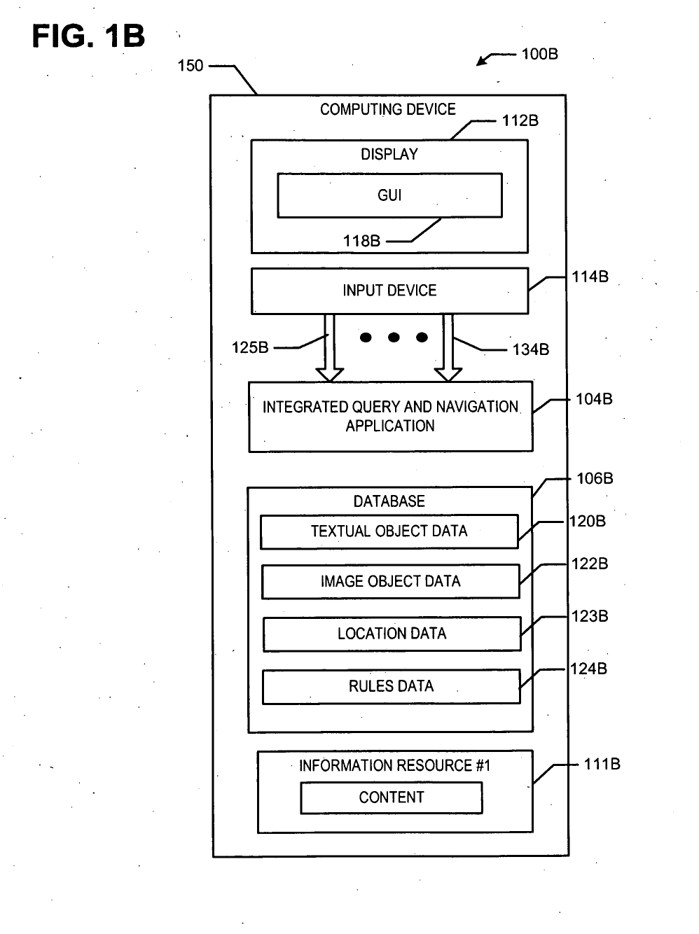

FIG. 1A depicts an exemplary embodiment of an IQNS 100A according to one aspect of the invention. The IQNS 100A includes a server computing device (“server”) 102A with an integrated query and navigation application (IQNA) 104A and a database 106A and communicates through a communication network 108A to a remote computing device (“remote device”) 110A.

The server 102A includes one or more processors and memory and is configured to receive data and/or communications from, and/or transmit data and/or communications to the remote device 110A via the communication network 108A.

One or more information resource or services (e.g., information resources #1-#N) 111A may be located on the server 102A (e.g., information resource #1) and/or provided from a service or content provider 112 located remotely from the server 102A (e.g., information resource #2, information resource #N). Each service or content provider 112 may include databases, memory, content servers that include web services, software programs, and any other content or information resource 111A. Such information resources 111A may also include web pages of various formats, such as HTML, XML, XHTML, Portable Document Format (PDF) files, information contained in an application or a website (either residing on the local drive, or a networked server), media files, such as image files, audio files, and video files, word processor documents, spreadsheet documents, presentation documents, e-mails, instant messenger messages, database entries, calendar entries, advertisement data, television programming data, a television program, appointment entries, task manager entries, source code files, and other client application program content, files, and messages. Each service or content provider 112 may include memory and one or more processors or processing systems to receive, process, and transmit communications and store and retrieve data.

The communication network 108A can be the Internet, an intranet, or another wired or wireless communication network. In this example, the remote device 110A and the server 102A may communicate data between each other using Hypertext Transfer Protocol (HTTP), which is a protocol commonly used on the Internet to exchange information between remote devices and servers. In another aspect, the remote device 110A, and the server 102A may exchange data via a wireless communication signal, such as using a Wireless Application Protocol (WAP), which is a protocol commonly used to provide Internet service to digital mobile phones and other wireless devices.

According to one aspect, the remote device 110A is a computing or processing device that includes one or more processors and memory and is configured to receive data and/or communications from, and/or transmit data and/or communications to the server 102A via the communication network 108A. For example, the remote device 110A can be a laptop computer, a personal digital assistant, a tablet computer, standard personal computer, a television, or another processing device. The remote device 110A includes a display 113A, such as a computer monitor, for displaying data and/or graphical user interfaces. The remote device 110A may also include an input device 114A, such as a keyboard or a pointing device (e.g., a mouse, trackball, pen, or touch screen) to enter data into or interact with graphical user interfaces.

The remote device 110A also includes a graphical user interface (or GUI) application 116A, such as a browser application, to generate a graphical user interface 118A on the display 113A. The graphical user interface 118A enables a user of the remote device 110A to interact with electronic documents, such as a data entry form or a search form, received from the server 102A, to generate one or more requests to search the database 106A for text objects and/or image objects that correspond to desired content, such as a particular web service, a web page for a dining establishment, a location for a retail establishment, or any other desired content. For example, the user uses the keyboard to interact with a search form on the display 113A to enter a search term that includes one or more characters. According to one aspect, the GUI application 116A is a client version of the IQNA 104A and facilitates an improved interface between the server 102A and the remote device 110A. It is also contemplated that the functionality of the input device 114A may be incorporated within a virtual keyboard that is displayed via the GUI 118A.

According to one aspect, the database 106A stores a plurality of objects (“objects”.) Each object corresponds to a different information resource or service (e.g., information resources #1-#N) and can represent metadata about one or more information resources or services, an article description for one or more information resources or services, data mined from one or more information resources or services, one or more hash tag representing one or more information resources or services, URL representing one or more information resources or services, or meta tags representing one or more information resources or services.

The objects stored on the database 106A can include text object data 120A and/or image object data 122A. Text object data (“text object”) 120A can include one or more characters of a word. For example, the following characters of the words “world series” can be objects “w”, “wo”, “wor”, “worl”, “world”, etc. Image object data (“image object”) 122A can include one or more images, symbols, icons, favicons, or any other non-textual representation associated with a desired information resource. For example, a favicon associated with a webpage or a web article could be used as an image object to symbolize or represent the webpage or article source for the purposes of navigating to that article. Each of the above objects 120A, 122A can include associated information, including a description or a location (e.g., URL) for a corresponding information resources or services.

According to one aspect, text objects 120A are indexed by search terms such that a particular search term references a particular list of text objects in the database 106A. For example, text objects 120A are indexed against documents that have previously been crawled and indexed based on key terms included in content, metadata, or other document data. It is contemplated that one or more text objects 120A included in a list of texts objects that correspond to a particular search term may also be included in another list of text objects that correspond to a different particular search term. Each text object 120A can also be associated with location data 123A that specifies a location (e.g., URL) of a corresponding document, software program, web service, etc on a communication network and/or within a data source.

According to one aspect, each text object 120A is further indexed such that it references a particular list of image objects in the database 106A. It is contemplated that one or more images included in a list of image objects that correspond to a particular text object 120A may also be included in another list of image objects that correspond to a different particular text object 120A. Each image object 122A can also be associated with location data 123A that specifies a location (e.g., URL) of a corresponding document, software program, web service, etc on a communication network and/or within data source. For example, image objects 122A are indexed against documents that have previously been crawled and indexed based on content, metadata, or other document data.

According to another aspect, the database 106A stores rules data 124A. The rules data 124A includes rules that govern when and/or which text objects 120A and image objects 122A are displayed in response to user input and selections received via an integrated query and navigation form. Although FIG. 1A illustrates the database 106A as being located on the server 102A, it is contemplated that the database 106A can be located remotely from the server 102A in other aspects. For example, the database 106A may be located on a database server or other data source (not shown) that is communicatively connected to the server 102A.

In operation, the server 102A executes the IQNA 104A in response to an access request 125A from the remote device 110A. The access request 125A is generated, for example, by the user entering a uniform resource locator (URL) that corresponds to the location of the IQNA 104A on the server 102A via the graphical user interface 118A at the remote device 110A. Thereafter, the user can utilize the input device 114A to interact with an integrated query and navigation data entry form (IQN form) received from the server 102A to enter search terms to generate text object requests 126A, image object request 128A, display request 130A, new text object request 132A, and/or new image object request 134A. For example, as explained in more detail below, the user can use an input device 114A to enter search terms via the IQN form. As the user enters each character of the one or more search terms into the IQN form, a text object request 126A and an image object request 128A are generated and transmitted to the IQNA 104A.

The IQNA 104A transmits a list of suggested text objects that correspond to the entered characters to the remote computing device 110A for display via the IQN form in response to the text object request 126A. The IQNA 104A also transmits a list of image objects that correspond to the selected text object to the remote computing device 110A for display via the IQN form in response to the image object request 128A. The user can use the input device 114A to further interact with the IQN form to select one of the image objects to generate the display request 130A to send to the IQNA 104A. The IQNA 104A transmits a corresponding information resource 111A to the remote computing device 110A for display via the IQN form in response to the display request 130A. By displaying suggested text objects and image objects as search terms are entered and enabling the simultaneous display of information resources, the IQNA 104A provides a more intuitive system for information retrieval. As explained in more detail below, the user can interact with the list of text objects displayed in the IQN form 302 to generate a new text object request 132A and/or new image object request 134A.

Although FIG. 1A illustrates a remote device 110A communicating with the server 102A that is configured with the IQNA 104A, in other aspects it is contemplated that an IQNS 100B can be implemented on a single computing device. For example, as shown in FIG. 1B, a computing device 150 executes an IQNA 104B and contains the database 106B. The database 106B stores similar object data (e.g., text objects and image objects), location data 123A, and rules data 124A to the data stored by database 106A described above in connection with FIG. 1A. As a result, a user may interact with data entry forms displayed via a graphical user interface 118B on a display 113B via the input device 114B to execute the IQNA 104B and to generate the various requests (e.g., 125B-134B), which are similar to the requests described above in connection with FIG. 1A (e.g., 125A-134A).

Although the integrated query and navigation system can be implemented as shown in FIGS. 1A and 1B, for purposes of illustration, the IQNA 104A is described below in connection with the implementation depicted in FIG. 1A.

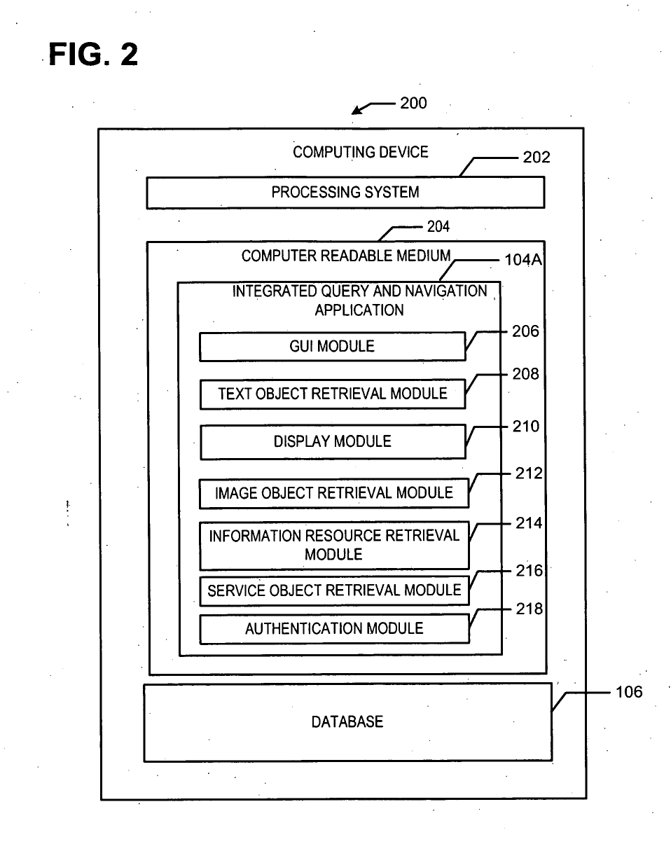

FIG. 2 is a block diagram depicting an exemplary IQNA 104A executing on a computing device 200. According to one aspect, the computing device 200 includes a processing system 202 that includes one or more processors or other processing devices. The processing system 202 executes an exemplary IQNA 104A to suggest search terms in response to one or more entered search terms, display images representative of desired information resources that correspond to selected suggested terms, and to simultaneously display a desired information resource that correspond to selected image.

According to one aspect, the computing device 200 includes a computer readable medium (“CRM”) 204 configured with the IQNA 104A. The IQNA 104A includes instructions or modules that are executable by the processing system 202 to enable a user to retrieve and display information resources.

The CRM 204 may include volatile media, nonvolatile media, removable media, non-removable media, and/or another available medium that can be accessed by the computing device 200. By way of example and not limitation, computer readable medium 204 comprises computer storage media and communication media. Computer storage media includes nontransient memory, volatile media, nonvolatile media, removable media, and/or non-removable media implemented in a method or technology for storage of information, such as computer readable instructions, data structures, program modules, or other data. Communication media may embody computer readable instructions, data structures, program modules, or other data and include an information delivery media or system.

A GUI module 206 transmits an IQN form to the remote device 110A after the IQNA 104A receives the access request 125A from the remote device 110A. As described above, the user of the remote device 110A then interacts with the various IQN forms to generate one or more other requests (e.g., requests 126A-134A) to submit to the IQNA 104A. FIGS. 2A-2X depict exemplary screen shots of the one or more input forms transferred to the remote device 110A by the GUI module 206.

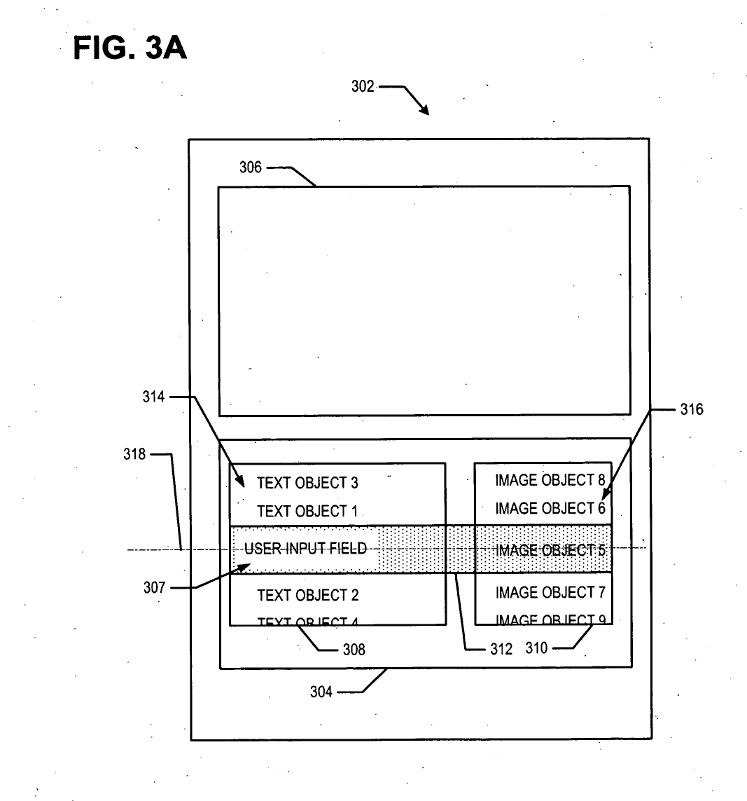

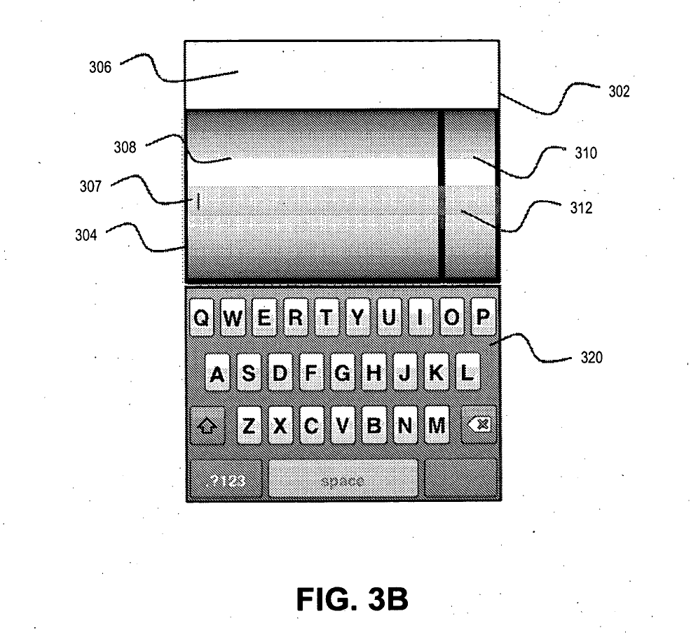

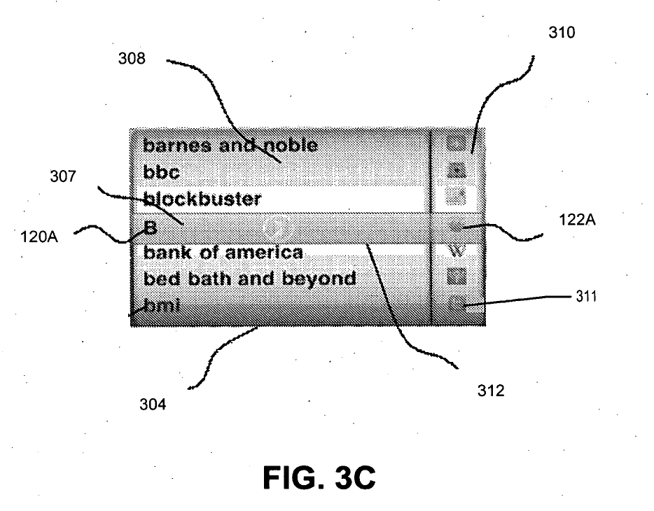

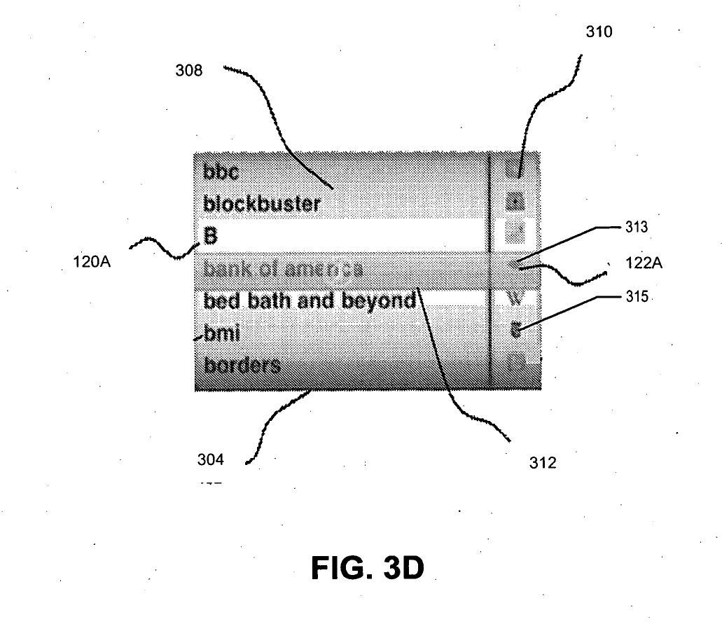

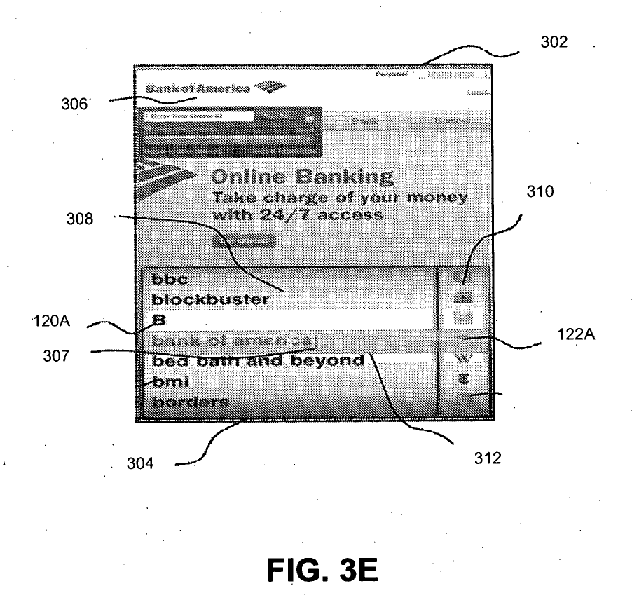

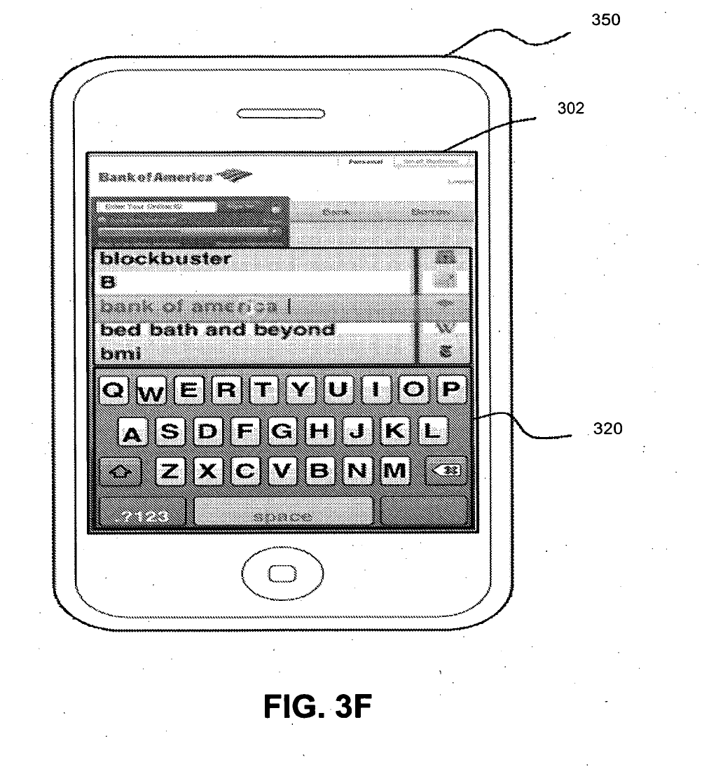

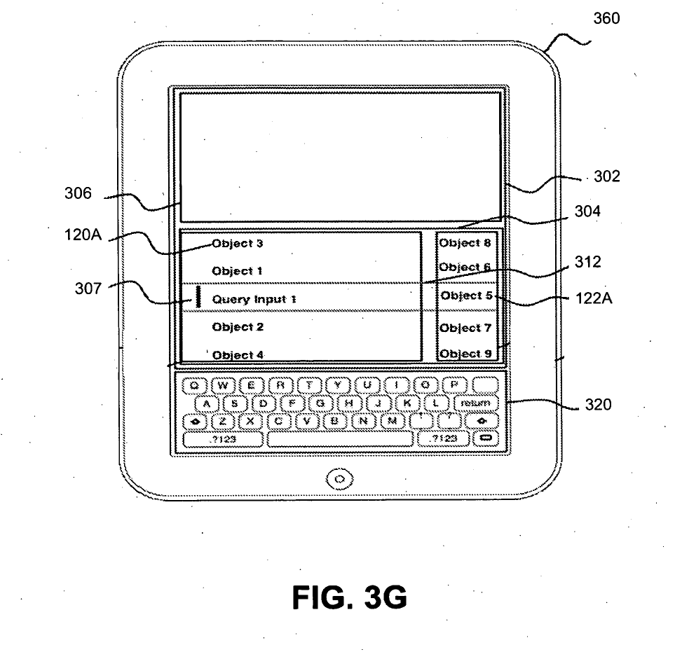

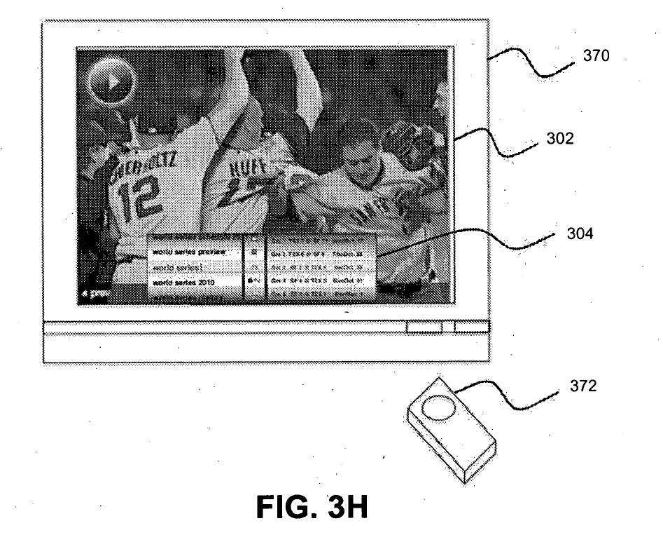

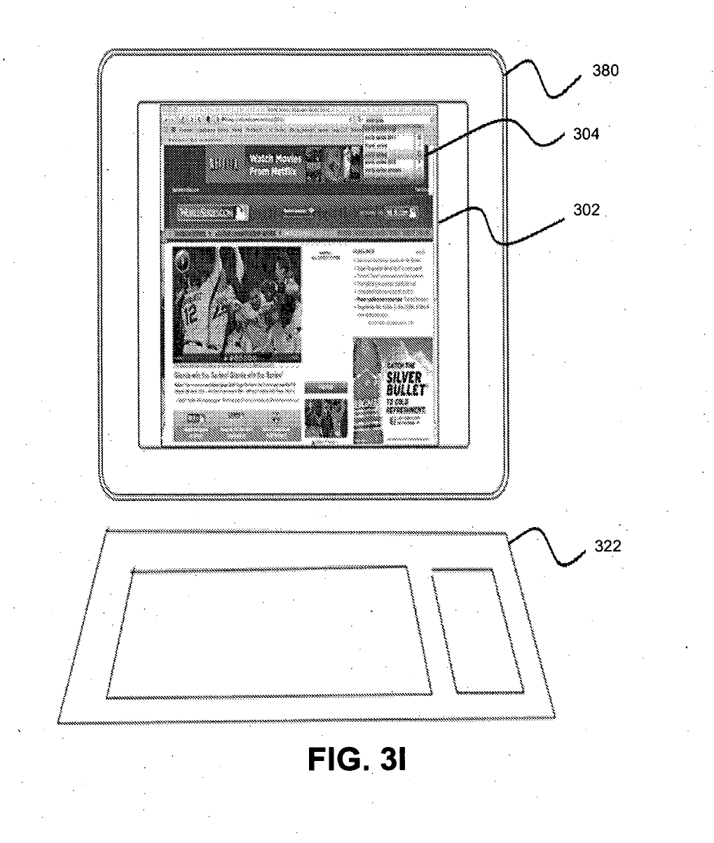

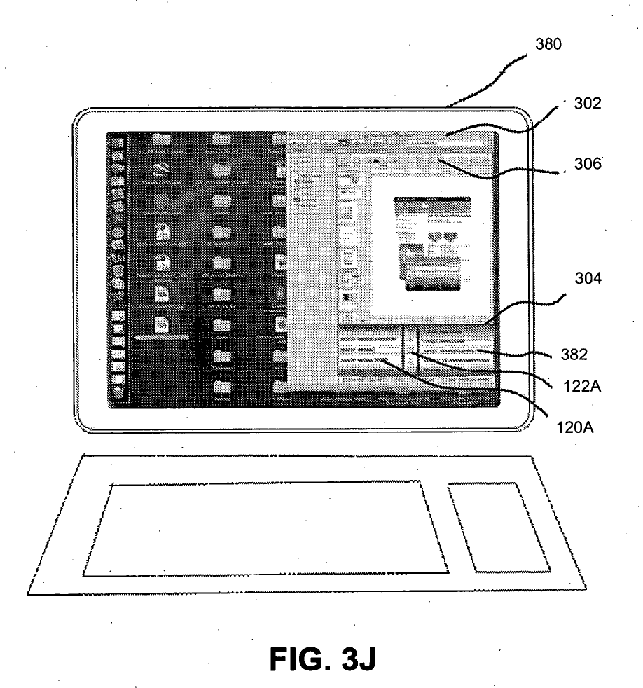

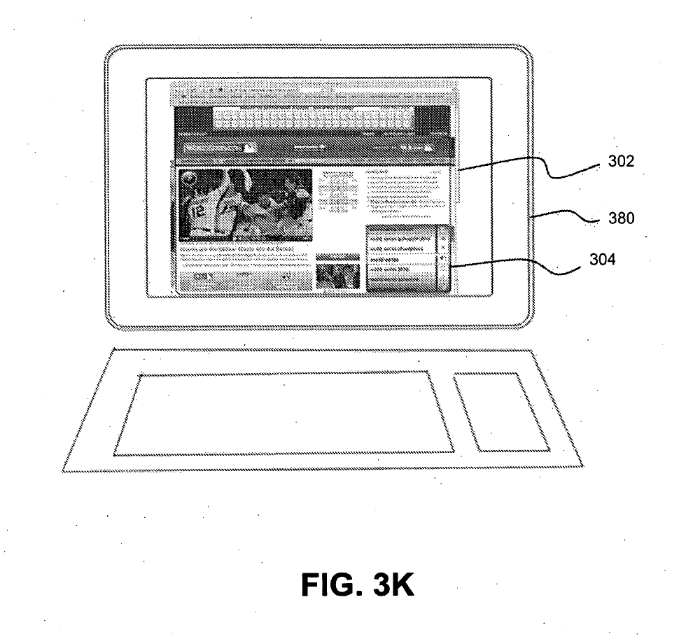

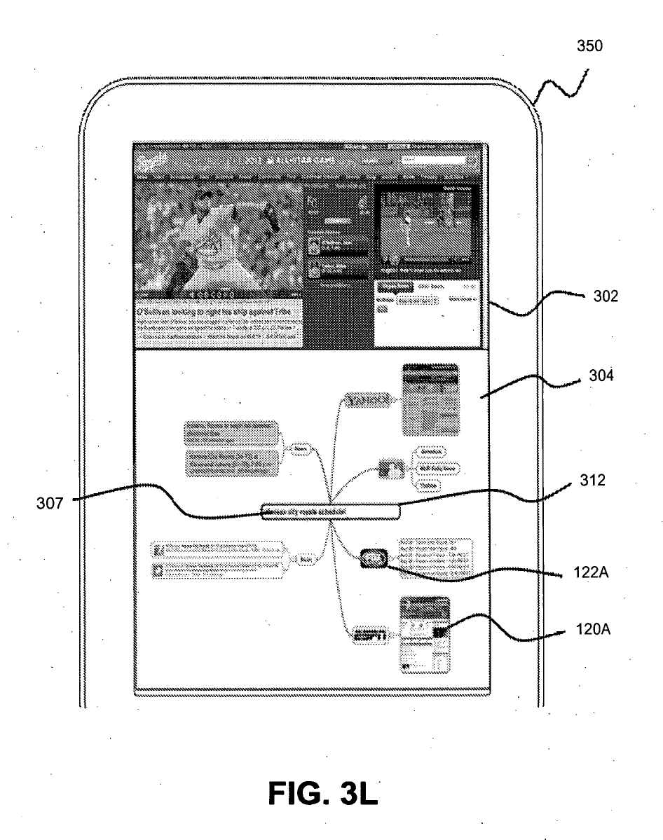

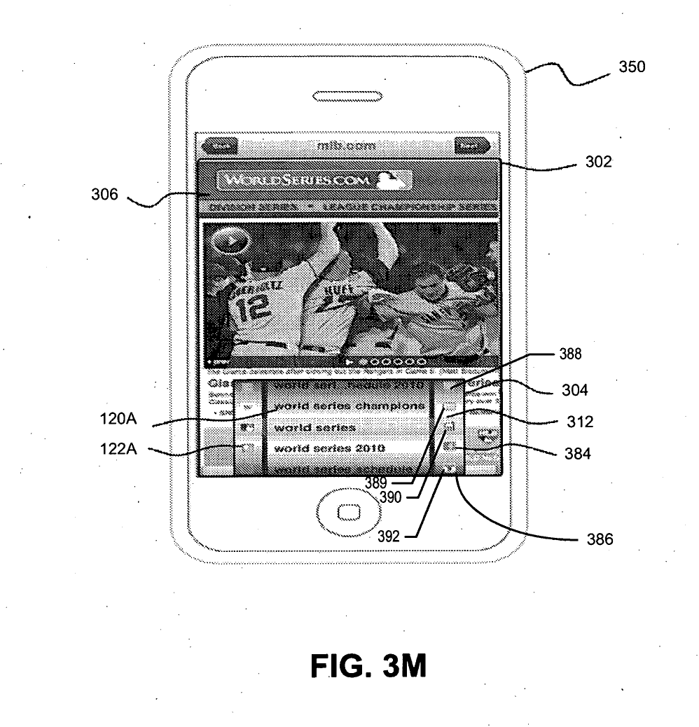

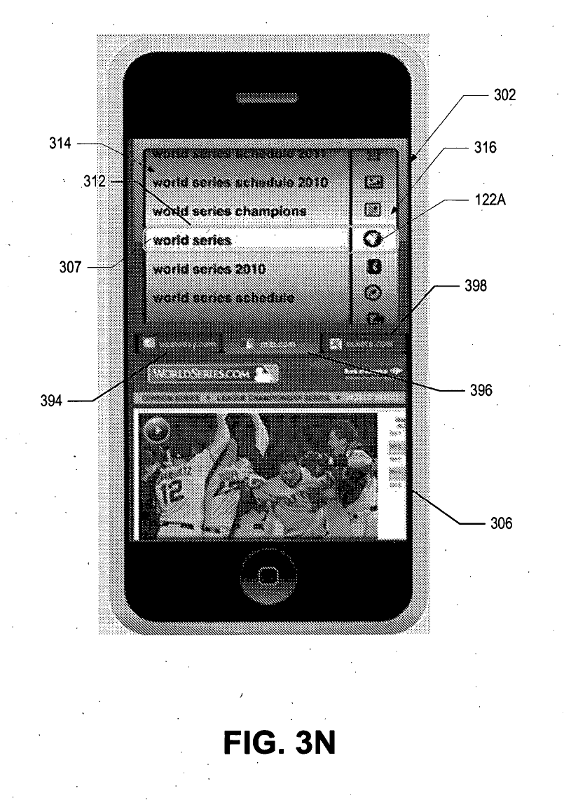

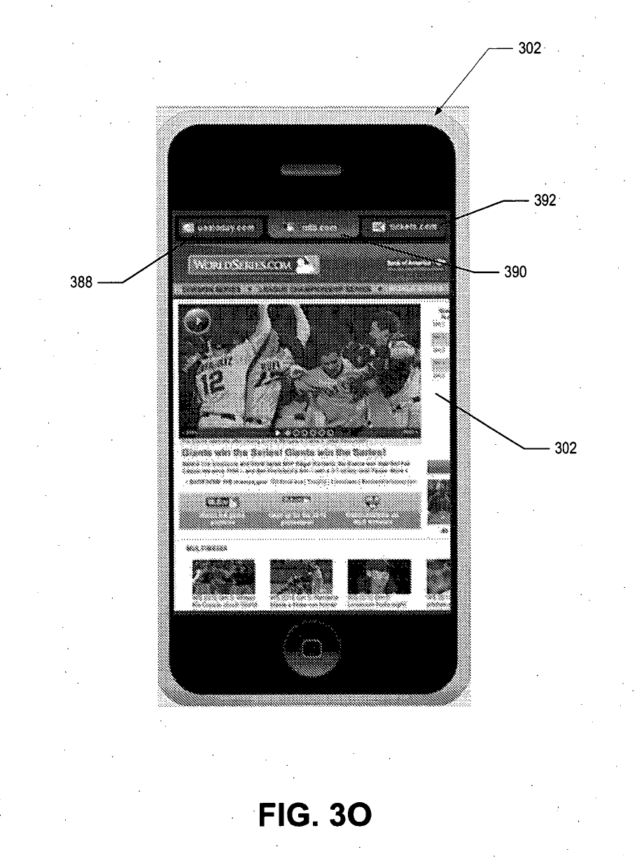

FIG. 3A depicts an exemplary IQN form 302 according to one aspect of the IQNS 100. The IQN forms 302 is, for example an HTML document, such as a web page that includes a query frame 304 for entering queries and viewing objects and an information resource viewing frame 306 for viewing an information resource (e.g., web site, web page, or other resource information) that corresponds to a selected text object or a selected image object.

The query frame 304 includes a query input field 307, a text object display window 308, an image object display window 310, and a selection window 312. The query input field 306 is configured to receive input from a user. As described above, as the user, enters each character of the one or more search terms into IQN form, a text object request 126A and/or a text object request 128A are automatically generated and transmitted to the IQNA 104A.

The text object display window 308 displays a list of text objects 314 transmitted from the IQNA 104A that correspond to entered characters of the search term(s) included in the text object request 126A. The list of text objects includes, for example, a list of suggested terms. For example, if the characters “Ba” have been entered into the input field 307, a list of suggested terms may include “ball”, “bat”, “base”, etc.

The image object display window 310 displays a list of image objects 316 transmitted from the IQNA 104A that correspond to entered characters of the search term(s) included in the text object request 126A. According to another aspect, the list of image objects 316 correspond to a selected suggested term (i.e., text object). The list of image objects 316 includes, for example, images that are representative of search results.

The selection window 312 denotes or indicates which particular text object and/or particular image object are currently selected from the corresponding lists 314, 316. In this example, the text object display window 308 and the image object display window 310 can be moved independently upward or downward, for example, in a ‘slot-machine’, or ‘spinning wheel’ motion. The selection window 312 includes two horizontal parallel lines centered on a vertical axis 318 of the windows 308, 310, such that objects in the center of the window 312 are deemed selected. Thus, new text and image objects 120A and 122A can be positioned within the selection window 312 by scrolling or moving the text object display window 308 and the image object display window 310 upward or downward. As described below in connection with FIG. 3M, it is contemplated that that in other aspects, the query frame 304 may include at least one other display window 308 for displaying other object types (e.g., service objects).

The information resource viewing frame 306 displays an information resource 111A that corresponds to a particular image object within the selection window 312. As described above, the information resources 111A can include a software application or computer program, a web site, a web page, web articles, or web services.

According to another aspect, when a different text object 120A in the text object display window 308 is positioned within the selection window 312 a new text object request 132A and/or a new image object request 134A are generated and transmitted to the IQNA 104A. The IQNA 104A transmits a new list of text objects for display in the text object display window 308 in response to the new text object request 132A. The new list of text objects includes, for example, a new list of suggested terms. The IQNA 104A also transmits a new list of image objects for display in the image object display window 310 in response to the new image object request 134A. The new list of text objects includes, for example, a new list of suggested images that each corresponds to an information resource.

According to another aspect, when a different image object 122A is positioned within the selection window 312, a new information resource that corresponds to the different image object 122A is displayed via the information resource viewing frame 306.

According to another aspect, a user can interact with a particular information resource 111A being displayed in the information resource viewing frame 306 to extract a word or an image in the information resource or service 111A to integrate such word or image into one or more of the information resource objects. For example, a word can be extracted from an information resource being displayed in the information resource viewing frame 306 and placed into the query input field 307 by extracting query words from information about the site (i.e. sitemap, meta-tags, etc.). Alternatively, a word can be extracted from an information resource being displayed in the information resource viewing frame 306 and placed into the query input field 307 when a user enters words into a site search bar. For example, after going to the <http://mlb.com> mlb.com<http://mlb.com> site with my ‘World Series’ query, if the user enter ‘KC Royals’ within .mlb's site search box, the terms ‘KC Royals’ are automatically placed into the query input field 307.

FIGS. 3B-3N depict screen shots of example IQN forms that can be displayed via various types of computing devices.

FIG. 3B shows an example of an IQN form 302 displayed by an IQNS 100A on a smart-phone type computing device with a virtual keyboard controller 320. In this embodiment, the IQN form 302 is displayed above the virtual keyboard controller 320. The query frame 304 of the IQN form 302 includes the text object display window 308 and the image object display window 310 that are configured in a “slot machine format.” Furthermore, the IQN form 302 includes a selection window 312. Contained within a selection window 312, is a query input field 307. According to one aspect, a blinking cursor encourages a user to input text utilizing the virtual keyboard controller 320. Finally, in this example embodiment the information resource frame 306 is located directly above the query frame 304. In this example, a user can easily interact with the IQN form 302 to select text objects 120A or image objects 122A by simply moving their finger in a upward on downward motion over the display windows 308, 310.

FIG. 3C depicts an example query frame 304 of the IQN form 302 described in FIG. 3B. In this example, query terms are automatically generated for display in the text object display window 308 and representative images or symbols of information resources 111A are automatically generated for display in the image object display window 310 based on the input of a character at the input field 307. In this example, the letter “B” has been entered into the query input filed 307. A text object request 126A is generated in response to the received input and the IQNA 104A retrieves a list of text objects 314 for display in the text object display window 308. According to one aspect, the IQNA 104A interfaces with a query suggestion service to retrieve the list of text objects 314. In this example, the suggested terms include “blockbuster”, “bank of america”, “bbc”, “bed bath and beyond”, “barnes and noble” and “bmi” to be placed in indexed locations vertically in the text object display window 308 within and around the selection window 312.

Furthermore, in response to the letter “B” entered into the input field 307, a image object request 128A is transmitted to the IQNA 104A to initiate a query of a database based on the letter “B” to retrieve a list of image objects 314 for display in the image object display window 310. In this example, the list of image objects 314 include favicon images such as “W” for Wikipedia and the trademark logo for twitter, as indicated by 311. In this example, the list of images objects 314 are representative images of the search results and are placed in indexed locations vertically in the image object display window 310 within and around the selection window 312.

FIG. 3D shows an alternative text object 120A in the text object display window 308 being selected by the user by moving this object to the information resource or service selector 134. By positioning the text object 120A “bank of america” into the selection window 312, a new image object request 132A is transmitted to the IQNA 104A to initiate a query of a database based on the characters “bank of america” to retrieve a new list of image objects 314 for display in the image object display window 310. This new list of image objects 314 include the trademark symbol for “Bank of America” as indicated by 313, the trademark symbol for “The New York Times” as indicated by 315, and the symbol “W” for Wikipedia. In this example, the new list of images objects 314 are representative images of the search results, are placed in indexed locations vertically in the image object display window 310 within and around the selection window 312. In this particular example, the list of text objects 312 did not changed based on “bank of america” being positioned within the selection window 312.

FIG. 3E shows an example screen shot of an IQN form 302 with an information resource for “Bank of America” displayed in the information resource frame 306 and the contents of the query frame 304 displayed in FIG. 3D.

FIG. 3F shows an example screen shot of an IQN form 302 with a ‘slot machine’ format and a virtual keyboard controller 320 for a smart phone-type device 350.

FIG. 3G shows an example an IQN form 302 with a ‘slot machine’ format for a tablet-type pc device 360 with a virtual keyboard controller 320.

FIG. 3H shows an example screen shot of an IQN form 302 with a ‘slot machine’ format for a television type device 370 with a remote controller 372. In this example, the ‘query frame includes three types of objects including suggest terms (e.g., text objects) in the left hand wheel, network channel branded favicons in the center wheel (e.g., image objects), and programming information shows, such as different games for the world series (e.g., programming objects) in the right hand wheel. Television-type devices contain on screen navigators that generally are not fully integrated with a query input mechanism, information objects and resources for previewing, while view the information resource in real-time.

FIG. 3I shows an example screen shot of an IQN form 302 with the query frame 304 embedded as a drop-down from the search box in a web browser for desktop or mobile computer 380 with a qwerty keyboard controller 322.

FIG. 3J shows an example screen shot of an IQN form 302 with the query frame 304 integrated with the desktop operating system for a desktop or mobile-type computer 380. In this example, the IQNA 104A is a desktop application that interfaces with a software program located on the client device to locate one or more objects (e.g., text objects, 120A, image objects 122A, and programming objects 382) placed in indexed location in the query frame. In this example, the object 382, or “Leap2_mockup.graffle” launches the application “Omnigraffle” for display via the information resource frame 306.

FIG. 3K shows an example screen shot of IQN form 302 where the query frame 304 is distributed in advertisement space embedded in a publisher website.

Alternative interactive information visualization interfaces can be contained in the query frame 304. Such interactive information visualization techniques that involve indexing information text objects and/or image objects to a location can include, for example a graph drawing.

FIG. 3L shows an example screen shot of IQN form 302 with a query frame 304 that displays of a ‘graph drawing’ interface type for a tablet personal computer (PC) 360. With this interface type example, for each object 120A or 122A, vertices and arcs are used to visually connect related vertices. Furthermore, the selection window 134 is denoted as select with the bold black box around the input field 307. In this example, the image object 122A is a favicon symbol for a website and text object 120A is a thumbnail image preview of the information resource or service.

FIG. 3M shows another example screen shot of an IQN form 302 for a smart-phone type device 500, with a third object 384 that represents a specific type of information resource, such as a service information resource type. In this example the service objects 384 are displayed in a third display window, service object display window 386, on the right side of the query frame 304. The service object display window 386 provides the user a further option to take some sort of action on a corresponding information resource. In this example, the user has the option to bookmark this site by selecting a bookmark service object, as indicated by 388, forward this site via email by selecting an email service object, as indicated by 389, forward a reference to this site as a mobile text message by selecting by selecting a mobile message service object, as indicated by 390, or add calendar information contained on the site by selecting a date service object, as indicated by 392.

FIGS. 3N and 3O show other example screen shots of an IQN form 302. In the example depicted in FIG. 3N, each of the image objects 122A in the list of image objects 316 are search category objects that correspond to entered characters of the search term(s) included in the text object request 126A. For example, each search category object in the display window 310 corresponds to search categories, such as local, images, web, directory, maps, etc. According to one aspect, the list of image objects 316 can be in the form of icons that are used to allow a user to navigate and select different “categories” or domains of information, including but not limited such information categories as: news, buzz, photos, phonebook, maps, Question & Answer, and Shopping. Thus, search terms can drive a unique set of categories for users to select from the display window 310.

The IQN form 302 depicted in FIG. 3N further includes resource information tabs 394, 396, 398. Each of the information resource information tabs 394, 396, 398 corresponds to a different information resource that corresponds to a selection of a particular search category object within the selection window 312. In this example, the information resource tabs 394, 396, 398 correspond to usatoday.com, mlb.com, and tickets.com, respectively. The information resource viewing frame 306 displays an information resource 111A that corresponds to the particular one of the information resource information tabs 394, 396, 398 selected by the user. According to one aspect, after a user selects a particular search category object, if the user enters alternative search term(s), the IQNS 100A resets the IQN form 302 to display a default information resource in the information resource viewing frame 306 and/or to display default information resource tabs 394, 396, 398 that correspond to the alternative search term(s).

According to another aspect, each of the information resource information tabs 394, 396, 398 corresponds to a different information resource that corresponds to the search results of a query initiated within the selection window 312. For example, assume a user initiates a query by selecting the terms “world series” from the list of text objects 314. In this example, the IQNS 100A displays the information resource in the frame that is the top natural search result and that corresponds to the mlb.com tab 396. The IQNS 100A also displays at least one tab that corresponds to a sponsored search result, such as paid advertisement search result. In this example, the IQNS 100A displays the tickets.com tab 398. Thereafter, the user can select the tickets.com tab 398 to display and access an information resource in the frame that corresponds to the tickets.com web site. According to one aspect, the advertiser associated with the sponsored search result tab pays the operator of the IQNS system or other advertisement partner a fee per click of the sponsored search result tab.

In an alternative aspect, if the user entered alternative search term(s), the IQNS 100A does not reset the IQN form 302, but rather displays an information resource in the frame and/or or the information resource the information resource tabs 394, 396, 398 that correspond to the alternative search term(s) and the category that corresponds to the particular search category object selected. That is, after a user selects a particular search category object, for example, from the list of image objects 316 in the right hand wheel, the user remains in or is anchored to that category. As a result, the user can select different text objects from the list of text objects 314 in the left hand wheel multiple times to repeatedly send different queries to that selected category of information. For example, assume a user selects a “Q&A” category and initiates a query by selecting the terms ‘Population KC’ from the list of text objects 314. Thereafter, the user can initiate another search of the selected “Q & A” category by selecting the terms ‘St. Louis Population’ form the list of image objects 316.

Referring back to FIG. 2, a text object retrieval module 208 retrieves a list of text objects (e.g., list of text objects 314) from the database 106A in response to the text object request 126A. For example, each text object request 126A includes one or more characters of search term. According to one aspect, the retrieval module 208 searches the database 106A to identify text objects that have been indexed or referenced against or otherwise defined to correspond to the same one or more characters. The text object retrieval module 208 generates the list of the text objects from the identified text objects that corresponds to one or more characters included in the text object request 126A.

A display module 210 transmits the list of text objects to the remote computing device 110A for display the IQN form. For example, as described above and illustrated in FIG. 2A, via the list of text objects 314 can be displayed via the text object window 208 of the IQN form 202.

An image object retrieval module 212 retrieves a list of image objects (e.g., list of image objects 316) from the database 106A in response to the image object request 128A. For example, each image object request 128A identifies a particular text object. According to one aspect, the image object retrieval module 212 searches the database 106A to identify image objects that have been indexed or referenced against or otherwise defined to correspond to the same particular text object. The image object retrieval module 212 generates the list of the image objects from the identified image objects that corresponds to text object identified in the image object request 128A. The display module 210 then transmits the list of image objects to the remote computing device 110A for display via the IQN form. For example, as described above and illustrated in FIG. 2A, the list of image objects 216 can be displayed via the image object window 210 of the IQN form 202.

An information resource retrieval module 214 retrieves a desired resource for display in response to a display request 130A. As described above, the display request 130A can be generated in response to a user positioning a particular image object within a selection window on the IQN form to designate that the particular image object is selected. Thus, each display request 130A identifies a particular image object. According to one aspect, the information resource retrieval module 214 searches the database 106A to identify a location, such as a URL, of a particular information resource that corresponds to the selected image objects. The display module 210 further retrieves the desired information resource from the identified location for display via the IQN form. For example, as described above and illustrated in FIG. 2A, the desired information resource can be displayed via the desired information resource frame 206 of the IQN form 202.

According to another aspect, the information resource retrieval module 214 is configured to concurrently retrieve a predicted desired resource for display along with the list of text objects and/or the list of image objects in response to the text object request 126A and/or the image object request 128A, respectively, based on the search terms entered into the query input field 307. In this aspect, the information resource retrieval module 214 searches the database 106A to identify a location, such as a URL, of a particular information resource that corresponds to the entered search terms. Thus, rather than waiting for a user to select from the list of text objects 314 displayed via the text object window 208 or the list of image objects 316 displayed via the image object window 210, the information resource retrieval module 214 automatically retrieves the predicted desired resource for display via the desired information resource frame 206 as the user enters search terms into the query input field 307.

According to one aspect, the information resource retrieval module 214 is configured to automatically retrieve the predicted desired resource via the desired information resource frame 206 of the IQN form based on the user behavior when entering text in query input field 307. For example, as the user inputs a textual query by, for example, typing, and then pauses for a minimum time period (e.g., 2-4 seconds), information resource retrieval module predicts the search term(s) based on the entered text prior to the pause. The information resource retrieval module 214 then searches the database 106A to identify a location, such as a URL, of a particular information resource that corresponds to the predicted search term(s).

As one example, the prediction may involve measuring the average time between each character entered, multiplying the measured time value by 2, and comparing the product to a defined threshold value to predict the user has completed a search entry. Stated differently, if the product of (2× measured time value) is greater that the defined threshold value, the search entry is deemed complete and the text and/or characters in query input field 307 are used as the predicted search term(s).

Similarly, it is also contemplated that the text object retrieval module 208 and/or the image object retrieval module 212 can be configured to retrieve the list of text objects (e.g., list of text objects 314) an/or list of image objects (e.g., list of image objects 316) from the database 106A, respectively, based on predicted search term(s).

According to another aspect, the text object retrieval module 208 also retrieves a new list of text objects from the database 106A in response to the new text object request 132A. As described above, the new text object request 132A is generated, for example, when the user interacts with the IQNA form to position a new text object within the selection window 312. The text object retrieval module 208 retrieves the new list of text objects from the database 106A in a manner similar to the processing of the text object request 126A described above. The display module 210 then transmits the new list of text objects to the remote computing device 110A for display the IQN form.

According to another aspect, the image object retrieval module 212 also retrieves a new list of image objects from the database 106A in response to the new image object request 134A. As described above, the new image object request 134A is generated, for example, when the user interacts with the IQNA form to position a new text object within the selection window 312. The image object retrieval module 208 retrieves the new list of image objects from the database 106A in a manner similar to the processing of the image object request 128A described above. The display module 210 then transmits the new list of image objects to the remote computing device 110A for display the IQN form.

It is also contemplated that the IQNA 104A can be configure with additional retrieval modules, such as a service object retrieval module 216, that can be utilized to retrieve a list of other object types in response to text object request and/or image object request. For example, the service object retrieval module 216 could be used to retrieve a list service options such as describe above in reference to FIG. 3M. In particular, the IQNA 104A can retrieve a list service options that are displayed via the service object display window 386 described in FIG. 3N. As describe above, such service options enable the user to bookmark a particular type of web site that corresponds to a particular type of information resource that provides a service. For example, a user may select a service object to access a web service that enables the user to forward a web site via email, forward the web site via mobile messaging, and/or or, add calendar information contained on the site.

According to another aspect, an authentication module 218 authenticates one or more request prior to displaying a particular information resource that corresponds to the predicted search term(s). Stated differently, the authentication module 218 authenticates authentication data supplied via the input query frame 304 prior to enabling the information resource retrieval module 216 to retrieve a desired resource for display in response to the display request 130A. For example, according to one aspect, the authentication module 218 authenticates a display request 130A by verifying that the user has selected two or more query words from the list of text objects that the user must know to access certain information resources, such as Twitter, Facebook, etc. The two or more query words may, for example, be predefined by the user and/or a service or content provider and correspond to a “password” or “pass phrase”.

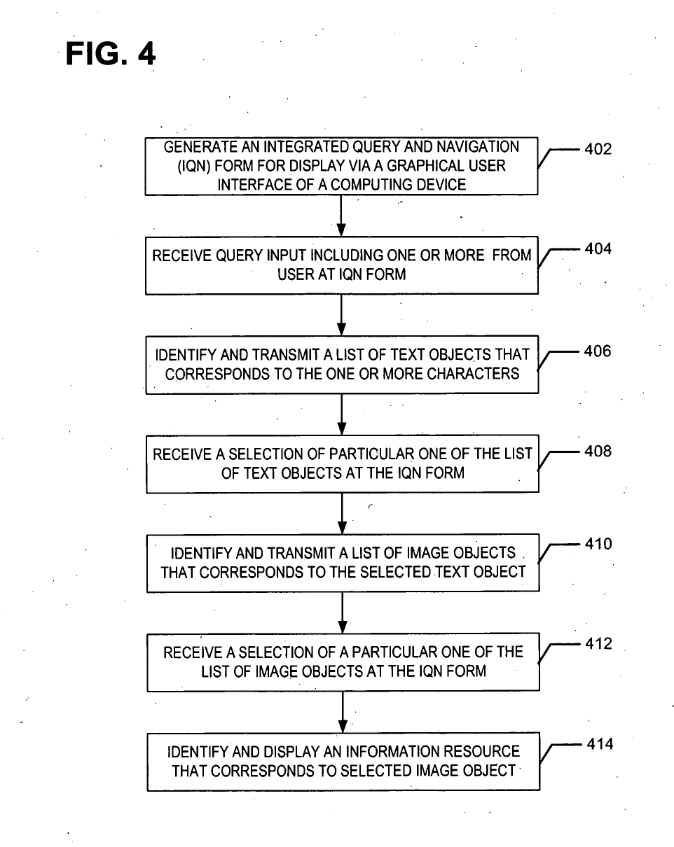

FIG. 4 is a flow chart that illustrates an exemplary method for retrieving and displaying information resources. An IQNA is executed and generates an IQN form for display via a graphical user interface of a computing device at 402. At 404, an input is received from a user via the integrated query and navigation form. The input includes one or more characters of a search term. The IQNA identifies a list of text objects that corresponds to one or more characters and transmits the list of text objects to the computing device 110A for display via the IQN form at 406. At 408, a selection of a particular one of the list of text objects is received from a user via the IQN form. The IQNA identifies a list of image objects that corresponds to one or more characters and transmits the list of image objects to the computing device 110A for display via the IQN form at 410. At 412, a selection of a particular one of the list of image objects is received from a user via the IQN form. The IQNA identifies an information resource that corresponds to the particular selected image object and displays the corresponding information resource via the IQN form at 414.

Those skilled in the art will appreciate that variations from the specific embodiments disclosed above are contemplated by the invention. The invention should not be restricted to the above embodiments, but should be measured by the following claims.

What is claimed is:

1. A system for displaying an information resource, the system comprising:
a computing device comprising at least one processor;
at least one data source comprising a plurality of first objects and a plurality of second objects, wherein each of the plurality of first objects comprises first object data defining at least one suggested term for a corresponding character entry and identifying location data for an information resource that corresponds to each suggested term, and wherein each of the plurality of second objects comprises second object data defining at least one symbol for the corresponding character entry and identifying other location data for another information resource that corresponds to each symbol; and
an application executable by the at least one processor to:
generate a graphical user interface at a display connected to the computing device, the graphical user interface comprising:
an information resource frame; and
a query frame comprising an input field, a first display window, and a second display;
retrieve the at least one suggested term from the at least one data source that corresponds to a particular character entry input at the input field;
retrieve the at least one symbol from the at least one data source that corresponds to the particular character entry input at the input field;
display the at least one suggested term in the first display window;
display the at least one symbol in the second display window;
retrieve a particular information resource in response to a selection of a particular corresponding symbol displayed in the second display window; and
display the particular information resource in the information resource frame.

2. The system of claim 1 wherein the at least one symbol is selected from a group consisting of an image, an icon, and a favicon.

3. The system of claim 1 wherein the at least one suggested term comprise one or more characters of a word.

4. The system of claim 1 wherein the particular information resource is selected from a group consisting of a software application, a computer program, a web site, a web page, web articles, and a web service.

5. The system of claim 1 wherein the computing device is selected from a group consisting of laptop computer, a personal digital assistant, a tablet computer, a standard personal computer, and a television.

6. The system of claim 1 wherein the plurality of first objects comprise text objects and the plurality of second objects comprise image objects.

7. The system of claim 1 wherein the graphical user interface displays a data entry form comprising the information resource frame and the query frame.

8. The system of claim 7 wherein the query frame further comprises a selection window, wherein the particular corresponding symbol is selected by moving the particular corresponding symbol within the selection window.

9. The system of claim 1 wherein the particular information resource is retrieved locally from the computing device.

10. The system of claim 1 wherein the particular information resource is retrieved remotely from a service provider.

11. A computing device encoded with an integrated query and navigation application comprising modules executable by a processor to display an information resource, the integrated query and navigation application comprising:
a GUI module to generate a graphical use interface at a display of the processing device, the graphical user interface comprising an information resource frame and a query frame comprising an input field, a first display window, and a second display window;
a first retrieval module to retrieve a plurality of first objects from a data source that corresponds to a particular character entry input at the input field, wherein each of the plurality of first objects comprises first object data defining at least one suggested term for a corresponding character entry and identifying location data for an information resource that corresponds to each suggested term;
a second retrieval module to retrieve a plurality of second objects from a data source that corresponds to a particular character entry input at the input field, each of the plurality of second objects comprises second object data defining at least one symbol for the corresponding character entry and identifying other location data for another information resource that corresponds to each symbol;
a display module to:
display the at least one suggested term in the first display window; and
display the at least one symbol in the second display window;
a third retrieval module to retrieve a particular information resource in response to a selection of a particular corresponding symbol displayed in the second display window; and
wherein the display module further displays a particular information resource in the information resource frame in response to a selection of a particular corresponding symbol displayed in the second display window.

12. The computing device of claim 11 wherein the at least one symbol is selected from a group consisting of an image, an icon, and a favicon.

13. The computing device of claim 11 wherein the at least one suggested term comprise one or more characters of a word.

14. The computing device of claim 11 wherein the third retrieval module is configure to retrieve the particular information resource form at least one of the computing device and a service provider.

15. The computing device of claim 11 being selected from a group consisting of laptop computer, a personal digital assistant, a tablet computer, a standard personal computer, and a television.

16. The computing device of claim 11 wherein the plurality of first objects comprise text objects and the plurality of second objects comprise image objects.

17. The computing device of claim 11 wherein the graphical user interface displays a data entry form comprising the information resource frame and the query frame.

18. The computing device of claim 17 wherein the query frame further comprises a selection window, wherein the particular corresponding symbol is selected by moving the particular corresponding symbol within the selection window.

19. A method for displaying an information resource, the method comprising:
generating a graphical user interface at a display of a processing device, the graphical user interface comprising an information resource frame and a query frame comprising an input field, a first display window, and a second display window;
retrieving a plurality of first objects from a data source that corresponds to a particular character entry input at the input field, wherein each of the plurality of first objects comprises first object data defining at least one suggested term for a corresponding character entry and identifying location data for an information resource that corresponds to each suggested term;
retrieving a plurality of second objects from a data source that corresponds to a particular character entry input at the input field, each of the plurality of second objects comprises second object data defining at least one symbol for the corresponding character entry and identifying other location data for another information resource that corresponds to each symbol;
displaying the at least one suggested term in the first display window;
displaying the at least one symbol in the second display window; and
displaying a particular information resource in the information resource frame in response to a selection of a particular corresponding symbol displayed in the second display window.

20. The method of claim 19 wherein the plurality of first objects comprise text objects and the plurality of second objects comprise image objects.

21. The method of claim 19 further comprising:
displaying a data entry form comprising the information resource frame and the query frame, wherein the query frame further comprises a selection window; and
receiving a selection of the particular corresponding symbol based on the particular corresponding symbol being moved within the selection window.

22. A system for displaying an information resource, the system comprising:
a computing device comprising at least one processor;
at least one data source comprising a plurality of first objects, a plurality of second objects, and a plurality of third objects, wherein:
each of the plurality of first objects comprises first object data defining at least one suggested term for a corresponding character entry and identifying location data for an information resource that corresponds to each suggested term;
each of the plurality of second objects comprises second object data defining at least one symbol for the corresponding character entry and identifying other location data for a first type of information resource that corresponds to each symbol; and
each of the plurality of third objects comprises third object data defining at least one other symbol for the corresponding character entry and identifying second other location data for a second type of information resource that corresponds to each other symbol; and
an application executable by the at least one processor to:
generate a graphical user interface at a display connected to the computing device, the graphical user interface comprising:
an information resource frame; and
a query frame comprising an input field, a first display window, and a second display;
retrieve the at least one suggested term from the at least one data source that corresponds to a particular character entry input at the input field;
retrieve the at least one symbol from the at least one data source that corresponds to the particular character entry input at the input field;
retrieve the at least one other symbol from the at least one data source that corresponds to the particular character entry input at the input field;
display the at least one suggested term in the first display window;
display the at least one symbol in the second display window;
display the at least one symbol in the third display window; and
display a particular information resource in the information resource frame in response to a selection of one of a particular corresponding symbol displayed in the second display window or in response to another selection of one of a particular corresponding other symbol displayed in the third display window.
